(19) United States
(12) Patent Application Publication
(10) Pub. No.: US 2006/0292946 A1
(43) Pub. Date: Dec. 28, 2006

(54) Financial Transaction Card With Embedded Fabric

(75) Inventor: John H. Kiekhaefer, Bloomingdale, IL (US)

Correspondence Address: WALTER W. DUFT;LAW OFFICES OF WALTER W. DUFT, 8616 MAIN ST, SUITE 2, WILLIAMSVILLE, NY, 14221, US

(73) Assignee: Perfect Plastic Printing Corporation, St. Charles, IL (US)

(21) Appl. No.: 11/380,869

(22) Filed: Apr. 28, 2006

Related U.S. Application Data
(60) Provisional application No. 60/693,124, filed on Jun. 22, 2005.

(51) Int. Cl. B32B 27/12; B32B 27/04

(52) U.S. Cl. 442/43; 442/59

(57) ABSTRACT

A financial transaction card having first and second thermoplastic material sheets each having first and second substantially planar surfaces bounded by a continuous peripheral edge. A fabric material sheet disposed between said first and second thermoplastic material sheets. At least one of the thermoplastic material sheets has a viewing area covering the fabric material sheet that is sufficiently transparent or translucent to human visible light to allow the fabric material sheet to be viewed through the viewing area, whereby the fabric material sheet imparts a visual effect to the card. A machine readable financial information storage or reference device is also provided for storing or referencing card user financial information.

### CROSS-REFERENCE TO RELATED APPLICATIONS

This application claims the benefit of U.S. Provisional Application Ser. No. 60/693,124, filed Jun. 22, 2005.

### BACKGROUND OF THE INVENTION

1. Field of the Invention

This invention relates generally to financial transaction cards, including credit cards, debit cards, ATM (Automated Teller Machine) cards, gift cards, telephone cards and others. More particularly, the invention relates to financial transaction cards that have novel visual features to enhance their aesthetic appearance.

2. Description of the Prior Art

For many years, entities offering financial transaction cards, such as financial institutions, retailers, telephone service providers and other card purveyors, have been interested in offering financial transaction cards that have a pleasing and distinctive visual appearance. The perceived advantage of such cards is the ability to offer a product that is unique in the marketplace, and which will impart status to the card customer relative to other card users who have more mundane cards. A card purveyor offering an attractive, visually distinct card can potentially attract customers who will preferentially select such a card over competitive cards that are less attractive, and thereby derive income as a result of increased card utilization.

There have been a number of previous efforts to improve the visual appearance of financial transaction cards. Exemplary manufacturing techniques include the following:
1) Incorporation of multicolor patterns and/or graphics into cards via printing;
2) Incorporation of optically varying and color shift pigments into cards via coatings or printing, or by incorporating pigments or particles in the plastic sheet stock;
3) Incorporation of pearl pigments into cards via coatings or printing, or by incorporating pigments or particles in the plastic sheet stock;
4) Incorporation of metallic appearing pigments into cards via coatings or printing, or by incorporating pigments or particles in the plastic sheet stock;
5) Incorporation of sparkle particles into cards via coatings or printing, or by incorporating pigments or particles in the plastic sheet stock;
6) Incorporation of holographic foil layers into cards;
7) Incorporation of a lenticular lens on the surface of cards in conjunction with an interlaced printed image; and
8) Incorporation of depth effects into cards through organized moire effects between printed layers and surface coatings.

It is to improvements in the design of visually distinctive financial transaction cards that the present invention is directed. What is particularly addressed is the need for a new design paradigm that provides new visual effects that have not been available heretofore using conventional financial transaction card visual enhancement techniques.

### BRIEF SUMMARY OF THE INVENTION

An advance in the art is provided by the present invention in which a financial transaction card has one or more areas that are optically enhanced using a fabric layer disposed within laminate layers of the card. The card includes a pair of first and second thermoplastic material sheets each having first and second substantially planar surfaces bounded by a continuous peripheral edge. A fabric material sheet is disposed between the thermoplastic material sheets. At least one of the thermoplastic material sheets has a viewing area covering the fabric material sheet that is sufficiently transparent or translucent to human visible light to allow the fabric material sheet to be viewed through the viewing area. In this way, the fabric material sheet will impart a visual effect to the card. The card also has a machine readable financial information storage or reference device.

According to exemplary embodiments disclosed herein, the first and second thermoplastic material sheets may be core sheets. Alternatively, one of the thermoplastic material sheets could be a core sheet and the other an outer overlay sheet. The fabric material sheet may be formed of fabric only, or it may comprise a laminate insert having fabric material disposed between a pair of thermoplastic cover sheets. The fabric material sheet may be coextensive with the continuous peripheral edges of the thermoplastic material sheets, such that the fabric material sheet covers opposing surfaces of the thermoplastic material sheets. Alternatively, the fabric material sheet could occupy less than the entire area of the thermoplastic material sheets. The viewing area may be coextensive with the continuous peripheral edge of the associated thermoplastic material sheet on which it is formed. In this way, the fabric material sheet will be viewable over the entirety of the thermoplastic material sheet except where other card features are present (e.g., printing, graphics, magnetic stripes, signature panels, etc.). Alternatively, the viewing area could occupy less than the surface area of the associated thermoplastic material sheet, such that the fabric material sheet is only viewable over a portion of the thermoplastic material sheet. The viewing area could then be shaped to provide a design effect. Moreover, the thermoplastic material sheet having the viewing area could be colored or otherwise visually modified outside of the viewing area to provide a non-viewing area that hides the fabric material sheet, or another viewing area that allows the fabric material sheet to be seen but whose optical properties differ from those of the first viewing area. If desired, both of the thermoplastic material sheets could have a viewing area covering the fabric material sheet that is sufficiently transparent or translucent to human visible light to allow the fabric material sheet to be viewed through both thermoplastic material sheets.

The financial transaction card may further include adhesive between the fabric material sheet and the thermoplastic material sheets. In most cases, one or both of the thermoplastic material sheets will have printed information on surfaces thereof that do not face the fabric material sheet. Overlay sheets may be used to cover the printed information.

The financial transaction card may be one of a credit card, debit card, automated teller machine (ATM) card, gift card, telephone card or any other card device used for financial transactions. The first and second thermoplastic material sheets may comprise a thermoplastic material selected from the group consisting of polyvinyl chloride (PVC), polyethylene terephthalate glycolized (PETG), unmodified amorphous polyethylene terephthalate (APET), acrylonitrile-butadiene-styrene (ABS), general purpose polystyrene (GPPS), high impact polystyrene (HIPS), and combinations thereof. The fabric material sheet may comprise a woven or non-woven fabric that is capable of being heat laminated to the first and second thermoplastic material sheets at a bond strength of at least 2.0 pound-foot/inches applied as a 90 degree peel force. A suitable fabric material sheet may comprise a fabric having a weight that does not exceed 0.15 grams/square inch. Examples include fabrics selected from the group consisting of mesh, fine polyester, metallic polyester, tulle, matte tulle, shiny tulle, sheer, fantasy sheer, organza, netting, nylon netting, lame', rainbow lame', metallic mesh, sheer pea, fine chiffon, net, fishnet, stretch, crepe, lace or holographic fabric. The visual effect imparted by the fabric material sheet could be decorative as a result of being one or more of metallized, reflective, pearlescent, translucent, fluorescent, sparkling, visually texturized, holographic, viewing angle-dependent color shifting, and viewing angle-dependent graphic pattern or visual texture shifting. The visual effect imparted by the first and/or second thermoplastic material sheets could be decorative as a result of being one or more of colored or tinted, metallic, visually texturized, reflective, pearlescent, sparkling, clouded, frosted, viewing angle dependent color shifting and holographic. The fabric material sheet, the first thermoplastic material sheet and the second thermoplastic material sheet may be decorative or non-decorative, in any desired combination.

In a further aspect of the invention, a method of forming a financial transaction card is provided. The method includes selecting first and second thermoplastic material sheets each having first and second substantially planar surfaces bounded by a continuous peripheral edge, placing a fabric material sheet between the first and second thermoplastic material sheets, and heat-laminating the thermoplastic and fabric material sheets to form a bonded laminate card structure. At least one of the thermoplastic material sheets has a viewing area covering the fabric material sheet that is sufficiently transparent or translucent to human visible light to allow the fabric material sheet to be viewed through the at least one thermoplastic material sheet. In this way, the fabric material sheet will impart a visual effect to the card.

### BRIEF DESCRIPTION OF THE SEVERAL VIEWS OF THE DRAWING

The foregoing and other features and advantages of the invention will be apparent from the following more particular description of a preferred embodiment of the invention, as illustrated in the accompanying Drawing, in which:

FIG. 1 is an exploded perspective view of a financial transaction card constructed in accordance with an exemplary embodiment of the present invention;

FIG. 2 is top plan view of the financial transaction card of FIG. 1;

FIG. 3 is bottom plan view of the financial transaction card of FIG. 1;

FIG. 4 is an exploded perspective view of a fabric material sheet insert that may be used in a financial transaction card;

FIG. 5 is an exploded perspective view of a financial transaction card constructed in accordance with an alternative embodiment of the present invention using the fabric material sheet insert of FIG. 4;

FIG. 6 is a photograph showing a financial transaction card constructed in accordance with Example 1 disclosed herein;

FIG. 7 is a photograph showing a financial transaction card constructed in accordance with Example 2 disclosed herein;

FIG. 8 is a photograph showing a financial transaction card constructed in accordance with Example 3 disclosed herein;

FIG. 9 is a photograph showing a financial transaction card constructed in accordance with Example 4 disclosed herein;

FIG. 10 is a photograph showing a financial transaction card constructed in accordance with Example 5 disclosed herein;

FIG. 11 is a photograph showing a financial transaction card constructed in accordance with Example 6 disclosed herein;

FIG. 12 is a photograph showing a financial transaction card constructed in accordance with Example 7 disclosed herein;

FIG. 13 is a photograph showing a financial transaction card constructed in accordance with Example 8 disclosed herein;

FIG. 14 is a photograph showing the front side of a financial transaction card constructed in accordance with Example 9 disclosed herein;

FIG. 15 is a photograph showing the back side of a financial transaction card constructed in accordance with Example 9 disclosed herein;

FIG. 16 is a photograph showing a financial transaction card constructed in accordance with Example 10 disclosed herein;

FIG. 17 is a photograph showing a financial transaction card constructed in accordance with Example 11 disclosed herein;

FIG. 18 is a photograph showing a financial transaction card constructed in accordance with Example 12 disclosed herein; and

FIG. 19 is a photograph showing a financial transaction card constructed in accordance with Example 13 disclosed herein.

### DETAILED DESCRIPTION OF EXEMPLARY EMBODIMENTS

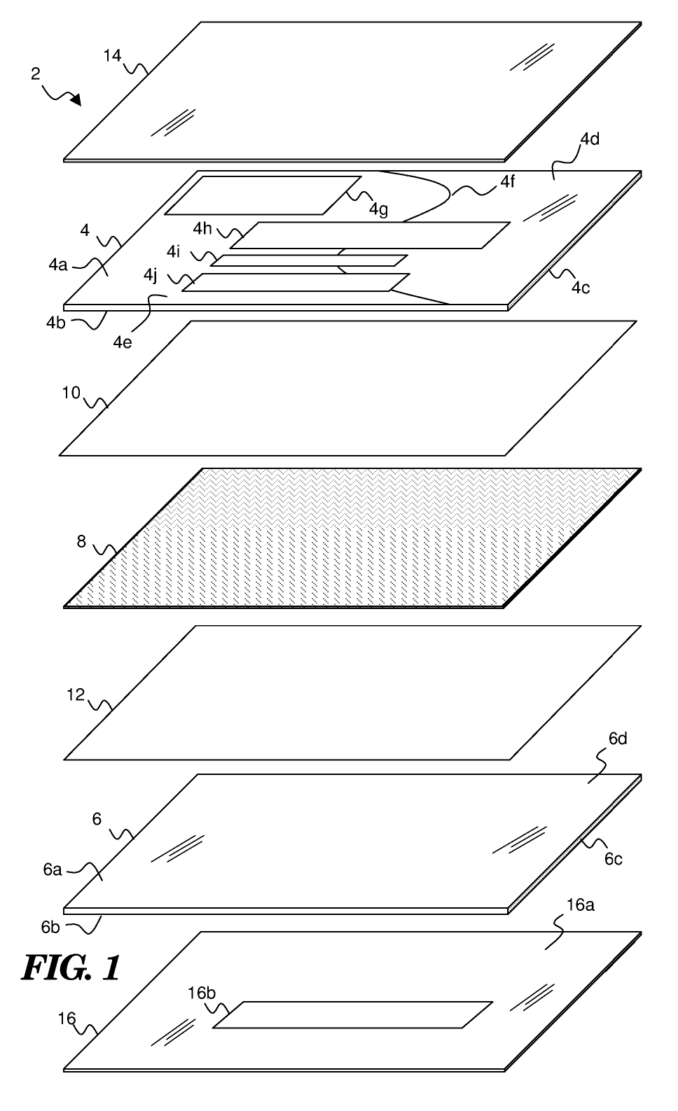

Turning now to FIGS. 1-3, a financial transaction card 2 constructed in accordance with an exemplary embodiment of the present invention has one or more areas that are optically enhanced using a fabric layer disposed within laminate layers of the card. The card 2 includes an upper thermoplastic material sheet 4 having first and second substantially planar surfaces 4a and 4b bounded by a continuous peripheral edge 4c, and a lower thermoplastic material sheet 6 having first and second substantially planar surfaces 6a and 6b bounded by a continuous peripheral edge 6c. A fabric material sheet 8 is disposed between the thermoplastic material sheets 6 and 8. Adhesive layers 10 and 12 are optionally coated on the thermoplastic material sheets 6 and 8 to help secure the fabric material sheet 8 using lamination heat and pressure. Alternatively, heat and pressure alone, without the adhesive layers 10 and 12, applied during card lamination may be sufficient to bond the thermoplastic material sheets 4 and 6 to the fabric material sheet 8. A pair of transparent overlay sheets 14 and 16 respectively cover the surfaces of the thermoplastic material sheets 4 and 6 that do not face the fabric material sheet 8. The overlay sheets 14 and 16 may be made of the same thermoplastic material as the thermoplastic material sheets 4 and 6, as described in more detail below.

At least one of the thermoplastic material sheets 4 or 6 has a viewing area covering the fabric material sheet 8 that is sufficiently transparent or translucent to human visible light to allow the fabric material sheet to be viewed through the viewing area. In this way, the fabric material sheet 8 will impart a visual effect to the card. In FIGS. 1-3, the thermoplastic material sheet 4 has an associated viewing area 4d, while the thermoplastic material sheet 6 has an associated viewing area 6d. Each viewing area 4d and 6d has selected optical properties (e.g., transparency, translucency, color (or absence of color), shading, patterning, pigmentation, etc.) that determine how the fabric material sheet 8 will appear within the card 2. As can be seen in FIG. 3, the viewing area 6d is coextensive with the continuous peripheral edge 6c. The fabric material sheet 8 is thus uniformly viewable (according to the optical properties of the viewing area 6d) over the entirety of the thermoplastic material sheet 6 in all areas that are not covered by other features, such as any printing, graphics, magnetic stripes, signature panels, or other matter that might be present on the surface 6b.

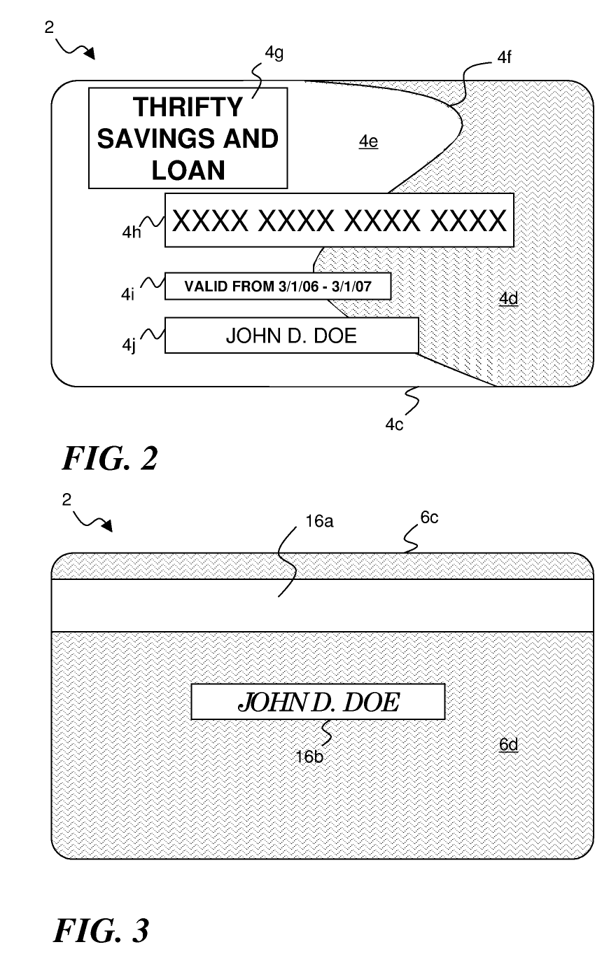

As can be seen in FIG. 2, the viewing area 4d extends over an area on the right side of the card 2 that is less than the entire surface area of the sheet 4. The fabric material sheet 8 is exposed for viewing through the first viewing area 4d according to its optical properties (e.g., transparency, translucency, color (or absence of color), shading, patterning, pigmentation, etc.). The thermoplastic material sheet 4 is further provided with a non-viewing area 4e that is not sufficiently transparent or translucent to permit viewing of the fabric material sheet 8. This non-viewing area 4e can be formed by printing an opaque ink of a desired color as a coating onto the surface 4a of the thermoplastic material sheet 4. The non-viewing area 4e is arbitrarily shaped with a curved edge 4f to provide a design effect. Although not shown, an alternative construction would be to form the area 4e as a second viewing area that does not block the fabric material sheet 8, but instead has different optical properties (e.g., transparency, translucency, color (or absence of color), shading, patterning, pigmentation, etc.) than the viewing area 4d. For example, instead of being opaque, the area 4e could be clouded, frosted, or have a different tint than the viewing area 4d, or it could be provided with other decorative effects, such as pearlescence, sparkles, or any other desired visual feature. In this way, the fabric material sheet could still be seen through the area 4e, but the fabric would appear differently than it does within the viewing area 4d. It will also be appreciated that more than two viewing areas could be provided on the same thermoplastic material sheet, depending on design preferences. The viewing areas could be of any desired shape and could each have unique optical properties that alter the appearance of the underlying fabric material sheet 8.

The financial transaction card 2 may be one of a credit card, debit card, automated teller machine (ATM) card, gift card, a telephone card or any other card device used for financial transactions. The thermoplastic material sheets 4 and 6 are commonly referred to in the relevant art as core sheets. Core sheets are the material sheets that occupy the central layers of a financial transaction card and provide at least 20% of its thickness. It is typical to provide two core sheets that are laminated back-to-back, with the outer sides of each core sheet being used for printing information and graphics. In the financial transaction card 2, the thickness of each thermoplastic material sheet 4 and 6 will typically range between 5-26 mils, assuming the card is to have an industry standard thickness range of 27-33 mils. Note that the thermoplastic material sheets 4 and 6 do not have to be of equal thickness. By comparison, the overlay sheets 14 and 16 would typically have an industry standard thickness of 1-2 mils each. The foregoing assumes that there are two core sheets present in the card 2. However, it would also be possible to construct the card 2 with more than two core sheets. In a further construction variation, instead of the fabric material sheet 8 being sandwiched by two cores sheets, it could be placed between a core sheet (e.g., thermoplastic material sheet 4 or 6) and one of the overlay sheets 14 or 16. This arrangement could even be used regardless of the number of core sheets that are present.

Suitable thermoplastics that may be used for the thermoplastic material sheets 4 and 6 (and for the overlay sheets 14 and 16) include materials selected from the group consisting of polyvinyl chloride (PVC), polyethylene terephthalate glycolized (PETG), unmodified amorphous polyethylene terephthalate (APET), acrylonitrile-butadiene-styrene (ABS), general purpose polystyrene (GPPS), high impact polystyrene (HIPS), and combinations of the foregoing materials.

In most cases, one or both of the thermoplastic material sheets 4 and 6 will have printed information on surfaces thereof. For example, either surface 4a or 4b of the thermoplastic material sheet 4 may be printed with a card provider name 4g, an account number 4h, validation information 4i, and a customer name 4j. Other graphical items may also be applied to the thermoplastic material sheets 4 and 6. The overlay sheets 14 and 16 are used to cover and protect the printed information during card use. A magnetic stripe 16a and a signature panel 16b are typically provided on the exposed outer surface of the overlay sheet 16. The magnetic stripe 16a stores financial information (e.g., identification data, credit data, debit data, etc.) in machine readable (e.g., digital) form. Other machine readable financial information storage or reference devices, such as microchips, barcodes, radio frequency identification tags, etc., could also be present. The financial transaction information could comprise an account number and/or account security information that is stored by the device, or it could comprise a code that corresponds to financial transaction information stored externally of the card (e.g., a barcode that when read allows financial transaction information associated with the card to be retrieved from a database).

The fabric material sheet 8 may be coextensive with the continuous peripheral edges 4c and 6c of the thermoplastic material sheets 4 and 6, such that the fabric material sheet is coextensive with the opposing surfaces 4b and 6a of the thermoplastic material sheets. This configuration is shown in FIGS. 1-3. Alternatively, the fabric material sheet 8 could occupy less than the entire area of the thermoplastic material sheets 4 and 6. The fabric material sheet 8 should be compatible with successful thermal lamination using conventional financial transaction card production lamination equipment. Currently, financial transaction cards are typically made of a multitude of thermoplastic layers (some printed) in large sheet form (e.g., from 12″×18″ to 48″×48,″ with 22.75″×27.75″ being typical). The large form sheets are laminated together in a platen press operation under heat and pressure. Multiple large form card sheets are often laminated in the platen press concurrently by interspersing pre-laminate lay-ups among sets of eleven polished rigid steel plates, with ten pre-laminate lay-ups to a lamination book, and several lamination books to a press loading (other book and press combinations are possible). A typical lamination cycle is 10-30 minutes of applied heat (e.g., 17 minutes) at a temperature of 200F-350F (e.g., 300F), followed by 10-30 minutes of cooling (e.g., 17 minutes), all under effective pressures ranging from 100 to 600 psi. After lamination, the sheets are cut into cards having a substantially rectangular shape with rounded comers and respective height and width dimensions of 2.125″×3.375″ (there are also several less popular sizes). Signature panels, hologram stamps, and embossments are then added to each card. Other features can be included in financial transactions cards such as chips and radio antennas incorporated into the core sheets before lamination or inserted into the finished card.

The fabric material sheet 8 should be capable of being sufficiently bonded within the card construction under these processing conditions, with or without the adhesive coatings 10 and 12, if possible, and with the adhesive coatings if needed. Sufficiently bonded means that the bond between the adjacent thermoplastic material sheets 4 and 6 to the fabric material sheet 8 should meet the requirements of prevailing industry standards applicable to financial transaction cards. Currently, the applicable specification (ISO/IEC7810(2003) calls for a bond strength of 2.0 lb.-ft./in. with a 90 degree peel per test method, as described in ISO/IEC10373-1(1998).

To achieve this bonding level, the fabric should be of such fiber composition, fiber density, thread diameter, weave and mesh that the thermoplastic material sheets 4 and 6 and/or the adhesive coatings 10 and 12, when softened during lamination, tend to permeate, saturate, encapsulate or otherwise adhere to the fibers during the thermal lamination process to a level that insures sufficient interlayer bonding. Meeting this requirement should also reduce the possibility that moisture can wick into the card construction via the fabric fibers from the edge of the card 2. It is believed that a good indicator of these factors and a good predictor of successful bonding of the fabric material sheet 8 into the card 2 is the weight per area measure on the fabric material. Applicant has determined that a fabric having a weight that does not exceed 0.15 grams/square inch is more likely to provide the necessary bond level, whereas a fabric having a weight in excess of 0.15 grams/square inch is less likely to be bondable to the needed standard (although there may be exceptions to this rule). Examples of fabrics that meet the preferred weight requirement include fabrics that are commonly referred to as being “sheer,” “fine,” “light weight” or “course weave.” Without limitation, such fabrics can be found in the following fabric industry categories: mesh, fine polyester, metallic polyester, tulle, matte tulle, shiny tulle, sheer, fantasy sheer, organza, netting, nylon netting, lame', rainbow lame', metallic mesh, sheer pea, fine chiffon, net, fishnet, stretch, crepe, lace and holographic fabric.

A preferable (but not necessarily required) feature of the card 2 is that it provide a decorative effect (as defined below). There are two ways that this can be manifested, either separately, or in combination. One is through use of a fabric material sheet 8 that has decorative optical properties itself. For example, there are fabrics in the above-referenced industry categories that produce visual effects that can be characterized as metallized, reflective, pearlescent, translucent, sparkling, visually texturized and/or holographic. Such fabrics can also produce such visual effects as color shifts, visual texture shifts, graphic pattern shifts, and special effect pattern shifts that vary with the angle of viewing. As used herein, a decorative fabric is a fabric that provides one or more of the foregoing decorative visual effects. A non-decorative fabric is a fabric that does not posses any of these visual effects.

Decorative visual effects may be imparted to the fabric material using a variety of methods, including but not limited to:
1) Metallization, deposition, embossing, heat transfer, printing, powder coating, and/or applied liquid coating across the entire face of the fabric;
2) Metallization, deposition, embossing, heat transfer, printing, powder coating, and/or applied liquid coating across portions of the face of the fabric;
3) Metallization, deposition, powder coating, and/or applied liquid coating on the fiber or threads (all or a portion) from which the fabric is made; and
4) Making the fabric from a synthetic fiber that has a decorative appearance incorporated inherently into it or onto its surface when the fiber is made.

The second method of imparting a decorative effect to the card 2 is if the thermoplastic material sheets 4 and/or 6 have inherent decorative optical properties themselves, either through constituent materials incorporated in the sheets themselves or through coatings laid upon them. In this case, the decorative effects of the thermoplastic material sheets 4 and/or 6 present themselves in the pattern or visual texture of the fabric material sheet 8. Optical properties considered to be decorative when associated with a thermoplastic material sheet are those whose visual effect can be characterized as colored or tinted, metallic, visually texturized, reflective, pearlescent, sparkling, clouded, frosted, viewing angle dependent color shifting and/or holographic. As used herein, a decorative thermoplastic material sheet is a thermoplastic material sheet that provides one or more of the foregoing decorative visual effects. A non-decorative thermoplastic material sheet is a thermoplastic material sheet that does not provide any of these visual effects.

Decorative visual effects may be imparted to a thermoplastic material sheets 4 and/or 6 using a variety of methods, including but not limited to:
1) Incorporation of optically varying and color shift pigments via coatings or printing, or by incorporating pigments or particles in the plastic sheet stock;
2) Incorporation of pearl pigments via coatings or printing, or by incorporating pigments or particles in the plastic sheet stock;
3) Incorporation of metallic appearing pigments via coatings or printing, or by incorporating pigments or particles in the plastic sheet stock;
4) Incorporation of sparkle particles via coatings or printing, or by incorporating pigments or particles in the plastic sheet stock; and
5) Incorporation of holographic foil layers;

Relative to this second method of imparting a decorative effect to the card 2, there is a significant specialized case. It has been determined that a fabric material sheet 8 with a significant amount of translucency can provide an organized decorative pattern when viewed against the background of a decorative thermoplastic material sheet (4 or 6) in the card 2. Suitable fabrics include materials that are translucent due to fiber translucency, or which are translucent due to use of a loose weave, knit or matte of the fabric. Examples of fabrics that may be translucent include plastic netting or mesh (nylon, polyester, etc.) having a tint, thickness and/or mesh size that results in translucency. A decorative effect can be produced as a result of the fabric material sheet 8 being backed by one of the thermoplastic material sheets 4 or 6 having decorative optical properties that may include such features as metallic particles, pearlescent powder or sparkles. Metallic silver and gold coatings are especially attractive. Due to the translucency of the fabric material sheet 8, the decorative aspects of the thermoplastic material sheet 4 or 6 will be visible through the fabric, with the fabric pattern adding to the decorative appearance.

Relative to this second method of imparting a decorative effect to the card 2, there is a second significant specialized case. It has been determined that a fabric material sheet 8 can provide an embossed pattern of the fabric material sheet 8 in a thermoplastic material sheet (4 or 6) if the thermoplastic material sheet has a reflective appearance incorporated to it by either a reflective or metallic coating thereon at the interface of bond with the fabric material layer 8. This fabric pattern embossment will also occur if a reflective foil layer is employed on the thermoplastic material sheet (4 or 6) at the interface between the thermoplastic material sheet and the fabric material sheet 8.

Summarizing the discussion thus far, it will be appreciated that a fabric-enhanced decorative effect may be provided in a financial transaction card using any combination of fabric and thermoplastic material sheet properties, including the following:
1) A non-decorative fabric viewable between non-decorative thermoplastic material sheets;
2) A decorative fabric viewable between non-decorative thermoplastic material sheets;
3) A decorative or non-decorative fabric viewable between thermoplastic material sheets, with one thermoplastic material sheet being decorative and altering the appearance of the fabric by providing a decorative filter through which the fabric is viewed or by providing a decorative background to view the fabric against;
4) A decorative or non-decorative fabric disposed between thermoplastic material sheets, with both thermoplastic sheets being decorative and altering the appearance of the fabric by providing a decorative filter through which the fabric is viewed or by providing a decorative background to view the fabric against;
5) A translucent fabric disposed between thermoplastic material sheets, with one thermoplastic material sheet (or possibly both sheets) being decorative and altering the appearance of the fabric by providing a decorative filter through which the fabric is viewed or by providing a decorative background to view the fabric against; and
6) A decorative or non-decorative fabric disposed between thermoplastic material sheets, with one thermoplastic material sheet being decorative as a result of having a reflective or metallized surface at the interface between that thermoplastic material sheet and the fabric sheet, thus providing an embossment of the fabric pattern in the metallized or reflective layer.

In any construction of the card 2, the fabric used in the fabric material sheet 8 can either be woven or non-woven, so long as it provides a noticeable visual effect (decorative or non-decorative) that can be seen through one or both of the thermoplastic material sheets 4 and 6. Preferably, the card 2 should appear to have actual fabric within its layers, as opposed to merely having a fabric-like pattern printed thereon. Whether the card 2 has a distinctive fabric appearance as opposed to a simulated fabric-like pattern printed thereon will depend on the physical characteristics of the fibers or threads, and whether the individual fibers or threads sit in the fabric web in a manner that conveys a genuine fabric appearance. Woven fabrics comprise two sets of interwoven threads (also known as yarns), with each thread being spun from a plurality of fibers. One set of threads, the warp, runs along the length of the fabric. The other set of threads, the fill or weft, is perpendicular to the warp. Woven fabrics are held together by weaving the warp and fill threads over and under each other. Closely related to woven fabrics are knit fabrics. Knit fabrics are made from only one set of threads, all running in the same direction. Some knits have their threads running along the length of the fabric, while others have their threads running across the width of the fabric. Knit fabrics are held together by looping the threads around each other. Non-woven fabrics are made directly from individual fibers that are matted together by forming an interlocking web of fibers either mechanically (tangling together) or chemically (gluing, bonding or melting together).

Specific fabric constructions that may be used in accordance with the invention include machine-woven or hand-woven fabrics, knitted fabrics, spun-lace fabrics, chemically-bonded fabrics, thermal-bonded fabrics, melt-blown fabrics, dry-laid fabrics, needle-punched fabrics, stitch-bonded fabrics, mesh fabrics and netting. Again, whether or not such fabrics impart a distinctive fabric effect to the card 2 will depend on the physical characteristics of the fibers or threads. By way of example, Table 1 correlates fabric characteristics with the ability to provide a distinctive fabric effect when used in a financial transaction card:

TABLE 1
Fiber/Thread Characteristics in Fabric
Related to Fabric Distinctive Effect
Fiber Length

| | |
|---|---|
| Short Fiber Length | Less Fabric Distinctive |
| Long Fiber Length | More Fabric Distinctive |

Fiber/Thread Thickness

| | |
|---|---|
| Thin Fiber or Thread | Less Fabric Distinctive |
| Thick Fiber or Thread | More Fabric Distinctive |

Fiber/Thread Orientation in Fabric Web

| | |
|---|---|
| Random Fiber Orientations | Less Fabric Distinctive |
| Organized Thread Orientations | More Fabric Distinctive |

Grouping of Parallel Threads in Fabric

| | |
|---|---|
| Small Grouping/Individual Threads | Less Fabric Distinctive |
| Large Grouping of Many Threads | More Fabric Distinctive |

Interleave Density of Cross Threads

| | |
|---|---|
| Dense Interleave | Less Fabric Distinctive |
| Loose Interleave | More Fabric Distinctive |

An additional consideration when selecting a fabric for the fabric material sheet 8 is whether the fibers have a composition that is resistant to water impregnation and biological or environmental attack through the card edge. Man-made fibers such as cellulose acetate, acrylic, nylon, polyester, polypropylene, rayon, polyethylene, glass, and blends of the foregoing, among others, would favor performance. Fibers that are subject to environmental degradation, such as cellulose, wool, cotton, and other natural materials, would not.

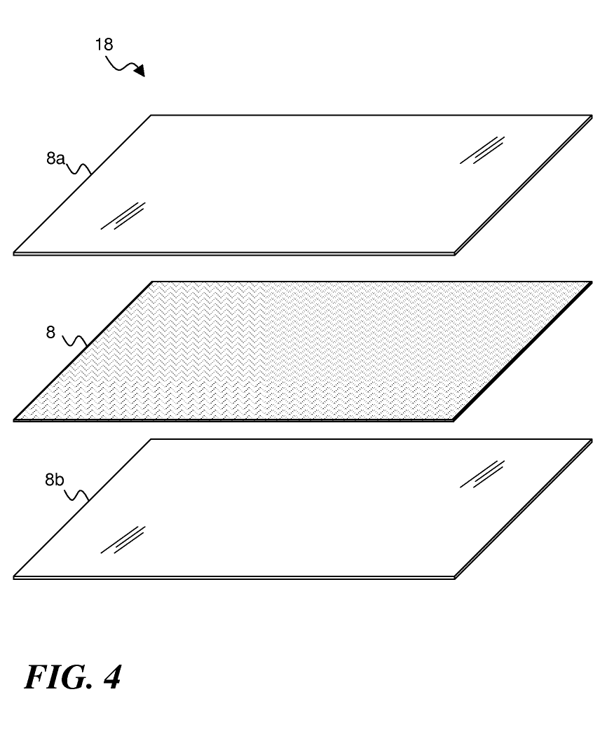

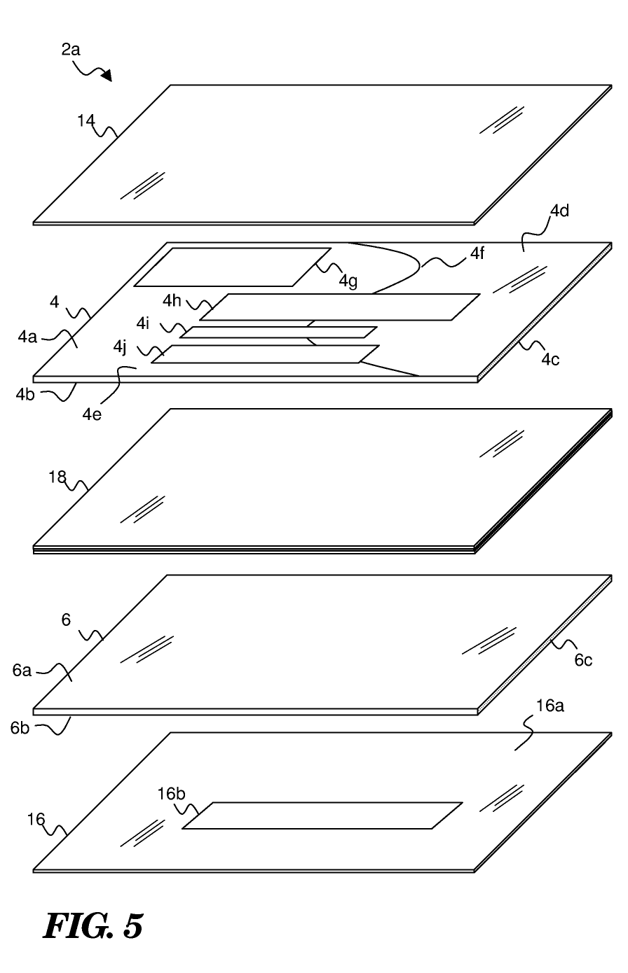

Turning now to FIGS. 4 and 5, a modification of the fabric material sheet 8 is shown. According to this construction, the fabric material sheet 8 is prelaminated between a pair of thin thermoplastic cover sheets 8a and 8b to form a sealed fabric insert sheet 18. In FIG. 5, a financial transaction card 20 is shown that is identical in all respects to the card 2 of FIG. 1, except that the fabric material sheet 8 is replaced with the sealed fabric insert sheet 18. Moreover, the adhesive layers 10 and 12 are not used. Still other constructions will no doubt also be apparent to persons skilled in the art in view of the teachings herein.

Specific construction will now be described by way of the examples given below. In each example, financial transaction cards were formed according to a method that included selecting first and second thermoplastic material sheets each having first and second substantially planar surfaces bounded by a continuous peripheral edge, placing a fabric material sheet between the first and second thermoplastic material sheets, and heat-laminating the thermoplastic and fabric material sheets to form a bonded laminate card structure. At least one of the thermoplastic material sheets had a viewing area covering the fabric material sheet that was sufficiently transparent or translucent to human visible light to allow the fabric material sheet to be viewed through the at least one thermoplastic material sheet, such that the fabric material sheet imparted a visual effect to the card.

### EXAMPLES

Presented below are thirteen (13) examples representing actual reduction to practice of the present invention. The design model used for Examples 1-6 is based on a seven (7) layer card in which the layers are as follows:

| | | |
|---|---|---|
| Layer 1 | Clear Thermoplastic Overlay (1-2 mils) | ------------------------------ |
| Layer 2 | Clear Thermoplastic Core Sheet (8-14 mils) | ------------------------------ |
| | (With printing and/or decorative coating on either side) | |
| Layer 3 | Optional Adhesive Coating on Core Sheet | ------------------------------ |
| Layer 4 | Decorative Fabric (<0.1 g/sq. in.) | ------------------------------ |
| Layer 5 | Optional Adhesive Coating on Core Sheet | ------------------------------ |
| Layer 6 | Clear Thermoplastic Core Sheet (8-14 mils) | ------------------------------ |
| | (With printing and/or decorative coating on either side) | |
| Layer 7 | Clear Thermoplastic Overlay (1-2 mils) | ------------------------------ |
| | (With Magstripe) | |

The design model for Examples 7-8 is based on a seven (7) layer card in which the layers are as follows:

| | | |
|---|---|---|
| Layer 1 | Clear Thermoplastic Overlay (1-5 mils) | ------------------------------ |
| Layer 2 | Clear Thermoplastic Core Sheet (8-14 mils) | ------------------------------ |
| | (With printing and/or decorative coating on either side) | |
| Layer 3, 4, 5 | Sealed Fabric Insert Sheet* | ------------------------------ |
| Layer 6 | Clear Thermoplastic Core Sheet (8-14 mils) | ------------------------------ |
| | (With printing and/or decorative coating on either side) | |
| Layer 7 | Clear Thermoplastic Overlay (1-5 mils) | ------------------------------ |
| | (With Magstripe) | |

The sealed fabric insert sheet is based on the three-layer construction of FIG. 4, as follows:
Layer 3 Clear Thermoplastic Sheet (1-2 mils)
Layer 4 Decorative Fabric (<0.1 g/sq.in.)
Layer 5 Clear Thermoplastic Sheet (1-2 mils)

The design model used for Example 9 is based on a seven (7) layer card in which the layers are as follows:

| | | |
|---|---|---|
| Layer 1 | Clear Thermoplastic Overlay (1-2 mils) | ------------------------------ |
| Layer 2 | Clear Thermoplastic Core Sheet (8-14 mils) | ------------------------------ |
| | (With printing and/or decorative coating on either side) | |
| Layer 3 | Near Infrared Blocking Coating on Core Sheet | ------------------------------ |
| Layer 4 | Decorative Fabric (<0.1 g/sq. in.) | ------------------------------ |
| Layer 5 | Near Infrared Blocking Coating on Core Sheet | ------------------------------ |
| Layer 6 | Clear Thermoplastic Core Sheet (8-14 mils) | ------------------------------ |
| | (With printing and/or decorative coating on either side) | |
| Layer 7 | Clear Thermoplastic Overlay (1-2 mils) | ------------------------------ |
| | (With Magstripe) | |

The design model used for Examples 10-12 is based on a seven (7) layer card in which the layers are as follows:

| | | |
|---|---|---|
| Layer 1 | Clear Thermoplastic Overlay (1-2 mils) | ------------------------------ |
| Layer 2 | Clear Thermoplastic Core Sheet (8-14 mils) | ------------------------------ |
| | (With printing and/or decorative coating on either side) | |
| Layer 3 | Optional Adhesive Coating on Core Sheet | ------------------------------ |
| Layer 4 | Translucent Fabric (<0.1 g/sq. in.) | ------------------------------ |
| Layer 5 | Bondable Decorative Coating on Core Sheet | ------------------------------ |
| Layer 6 | Opaque or (Clear) Thermoplastic Core Sheet (8-14) | ------------------------------ |
| | (With printing on outer side (or inner side if clear) | |
| Layer 7 | Clear Thermoplastic Overlay (1-2 mils) | ------------------------------ |
| | (With Magstripe) | |

The design model used for Example 13 is based on an eight (8) layer card in which the layers are as follows:

| | | |
|---|---|---|
| Layer 1 | Clear Thermoplastic Overlay (1-2 mils) | ------------------------------ |
| Layer 2 | Clear Thermoplastic Core Sheet (0-25 mils) | ------------------------------ |
| | (With printing and/or decorative coating on either side) | |
| Layer 3 | Optional Adhesive Coating on Core Sheet | ------------------------------ |
| Layer 4 | Translucent Fabric (<0.15 g/sq. in.) | ------------------------------ |
| Layer 5 | Optional Adhesive Coating on Core Sheet | ------------------------------ |
| Layer 6 | Clear Thermoplastic Core Sheet (1-25) | ------------------------------ |
| Layer 7 | Bondable Decorative Coating on Core Sheet | ------------------------------ |
| | (With printing thereon) | |
| Layer 8 | Clear Thermoplastic Overlay (1-2 mils) | ------------------------------ |
| | (With Magstripe) | |

Except where otherwise noted, all examples were constructed and tested using the following equipment, materials and methods:

Lamination Equipment and Method

1) Oasys OLA6/7 Desktop Laminator with 5 polished steel plates (4.5″×6.25″) (Oasys Technologies Ltd., Jubilee Trade Centre, Letchworth Garden City, Herts SG6 1SP, England, Tel: +44 1462 480933)

1A) Laminations run at the following machine settings:
Laminating Temperature: 165 C
Low Pressure: 74 units
Hold Time: 30 seconds
High Pressure Temperature: 105 C
High Pressure: 77 units

2) Burkle Smartlam Model CHK with 11 polished steel plates per book (22.75″×27.75″, 10 laminated plastic sheets per book (Burkle North America, Inc., 12802 Valley View Street, Suite 12/13, Garden Grove, Calif. 92845) (Example 9 only)

2A) Laminations run at the following machine settings:
a) Heat cycle: 320 F set temperature for 17 minutes at 220 psi
b) Cooling cycle: 2 minutes at 250 psi and 15 minutes at 320 psi
   Cutting Equipment

PMC Diecutting Machine Series F86 (Printing Machines Co. Division of Stewart Industries, 7234 Blue Ash Road, Cincinnati, Ohio 45236) (Example 9 only)

Test Equipment

1) Mitutyoyo Micrometer (0.00001 inch precision) (Mitutyoyo America Corp, 965 Corporate Blvd., Aurora, Ill. 60504, Tel: 630-820-9666)

2) Thwing Albert 225-1 Friction/Peel Tester (Thwing Albert Instrument Co., 14 Collings Ave., West Berlin, N.J. 08091, Tel: 856-767-1000)

3) Datacard 150i Embosser (Datacard Corp., 11111 Bren Road West, Minnetonka, Minn. 55343-9015, Tel: 952-933-1223)

Plastic Materials

1) Card materials cut to 4.5″×6.25″ for Oasys OLA6/7 lamination

2) Clear PVC Overlay—Klöckner CC-L280/07 with W5-51×704 adhesive 1.6 mils (Klöckner Pentaplast of America, Inc., 3585 Klöckner Road, Gordonsville, Va. 22940, Tel: 540-832-3600)

3) Opaque White PVC Core—Klöckner CC-M230/18 13.5 mils

4) Clear PVC Core Sheet—Klöckner CC-M278/12 13.4 mils

5) Opaque Black PVC Core Sheet—Bolatron Empire Black #34320 Color 2917 10.0 mils (Piedmont Plastics, Inc., 5010 West W.T. Harris Blvd, Charlotte, N.C. 28269, Tel: 704-597-8200)

Magnetic Stripes

1) DIC 330 2750 Oersted Brown Magstripe (DIC International (USA), LLC, Glenpointe Center West, 500 Frank W. Burr Blvd., Teaneck, N.J. 07666)

2) Kurz Transfer Products High Coercivity 330 2750 Oersted Silver Magstripe (Kurz Transfer Products L.P., 3200 Woodpark Blvd., Charlotte, N.C. 28206) (Example 9 only)

Coating Materials

1) SQL Clrl Adhesive (Fujifilm Sericol USA, 1101 W. Cambridge Dr., Kansas City, Kans. 66103, Tel: 913-342-4060)

2) Wink 8S2212 Silver S-22 Coating (FM Group, 150 Route 17, P.O. Box 46, Sloatsburg, N.Y. 10974)

3) Epolin Epolight 2066 (Epolin Inc., 358-254 Adams Street, Newark, N.J. 07105) (Example 9 only)

4) H. W. Sands SDA8630 (H. W. Sands Corp., 1080 East Indiantown Road, Suite 206, Jupiter, Fla. 33477) (Example 9 only)

5) Nazdar PB22 Blue (Nazdar International, 8501 Hedge Lane, Terrace Shawnee, Kans. 66227) (Example 9 only)

6) Degussa Acematt HK450 (Degussa Corporation, 8300 W. Factory Road, Mapleton, Ill. 61547) (Example 9 only)

7) Apollo S10840 Vehicle (Apollo Chemical Corporation, 1105 Southerland Street, Graham, N.C. 27253) (Example 9 only)

8) Decorative Adhesive Coating Formula 031605a (Examples 5-6 and 10-13 only):
SQL Clrl Adhesive 20.0 parts
Wink 8S2212 Silver S-22 Coating 80.0 parts

6) Near Infrared Blocking Adhesive Formula 122205a (Example 9 only):

| | | |
|---|---|---|
| Epolin Epolight 2066 | 4.0 | g |
| H. W. Sands SDA 8630 | 0.5 | g |
| Nazdar PB22 Blue | 40.0 | g |
| Degussa Acematt HK450 | 15.0 | g |
| Apollo S10840 Vehicle | 940.5 | g |

Fabric Materials

1) Wholesale Suppliers:
a) Associated Fabric Corporation, 104 East 25th Street, New York, N.Y. 10010, Tel: 212-689-7186 (http://www.afcnewvork.com/core.html)
b) ADO International, 851 Simuel Road, Spartanburg, S.C. 29301 (Example 9 only)

2) Retail Supplier:

Hobby Lobby Creative Ctr, 1851 N. Neltnor Blvd, West Chicago, Ill. 60185, Tel: 630-293-4550

3) Fabric Materials Available For Use in Reduction to Practice Examples:

Green Metallic Mesh, Red Metallic Mesh, Gold Metallic Mesh, Heavy Gold/Black Metallic Mesh, Pink Rainbow Lame', Blue Rainbow Lame', Violet Rainbow Lame', Blue Nylon Netting, Pink Shiny Organza, Violet Shiny Organza, Light Gold Sheer Pea, Heavy Gold Sheer Pea, Blue Sheer Pea, Blue Tulle, Eurohem

### Example 1

Card structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Blue Rainbow Lame' 0.04 g/sq. in. (Hobby Lobby) | --------------- |
| Layer 5 | Sericol SQL Clr1 Adhesive 160 mesh screen applied to layer 6 | --------------- |
| Layer 6 | Klöckner CC-M230/18 white PVC core 13.5 mils | --------------- |
| Layer 7 | Klöckner CC-L280/07 with W5-51 × 704 adhesive 1.6 mils | --------------- |
| | (With Magstripe) | |

Card Features:

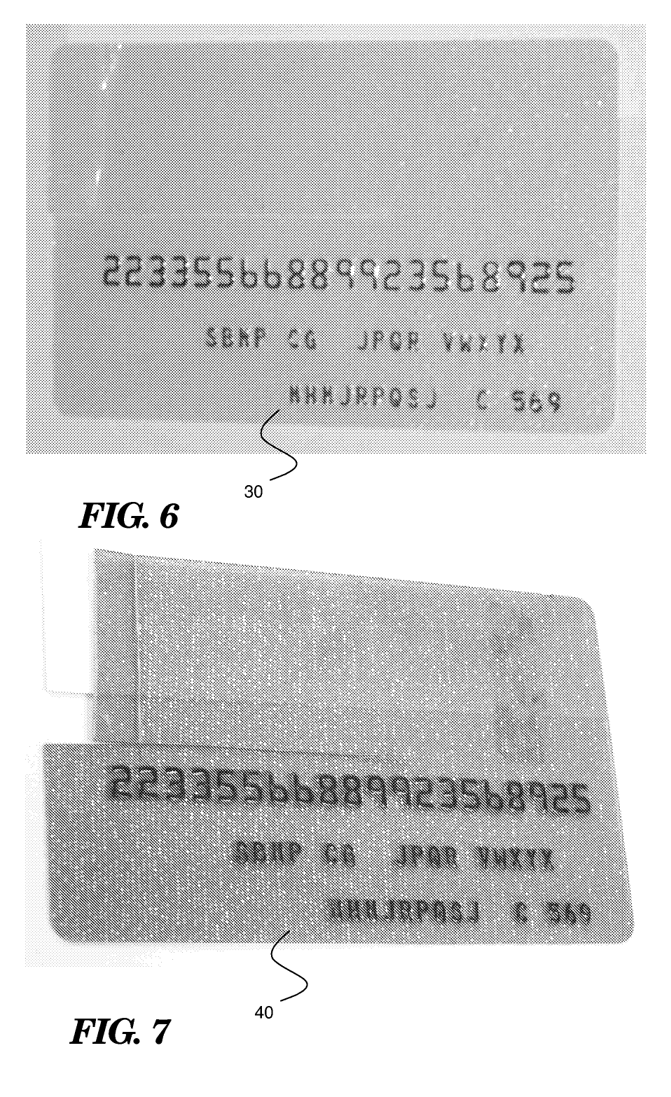

A photograph of the card produced by this example is shown by reference numeral 30 in FIG. 6. The card 30 had a total thickness of 29.7 mils. Following lamination, the card 30 was conventionally embossed without splitting or cracking. The bond between core sheets (layers 2 and 6) and the fabric (layer 5) was not separable by hand pull and thus greater than 2.0 lb.-ft./inch. The card 30 was opaque and opalescent. When viewed straight-on, the card 30 had a visible organized multicolor sparkle pattern that followed the fabric grid. The sparkle pattern shifted in position when viewed at 20-25 degrees from normal. When viewed at 45 degrees from normal, the sparkle pattern was not visible.

### Example 2

Card structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Light Gold Sheer Pea 0.078 g/sq. in. (Hobby Lobby) | --------------- |
| Layer 5 | Sericol SQL Clr1 Adhesive 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |
| | (With Magstripe) | |

Card Features:

A photograph of the card produced by this example is shown by reference numeral 40 in FIG. 7. The card 40 had a total thickness of 31.2 mils. Following lamination, the card 40 was conventionally embossed without splitting or cracking. The bond between core sheets (layers 2 and 6) and the fabric (layer 5) was not separable by hand pull and thus greater than 2.0 lb.-ft./inch. The card 40 was translucent. When viewed straight-on, the card 40 had a visible organized multicolor sparkle pattern that followed the fabric grid. The sparkle pattern was of greater brightness when viewed at 45 degrees from normal. When viewed at 70 degrees from normal, the sparkle pattern was not visible.

### Example 3

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Red Metallic Mesh 0.023 g/sq. in. (Hobby Lobby) | --------------- |
| Layer 5 | Sericol SQL Clr1 Adhesive 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |
| | (With Magstripe) | |

Card Features:

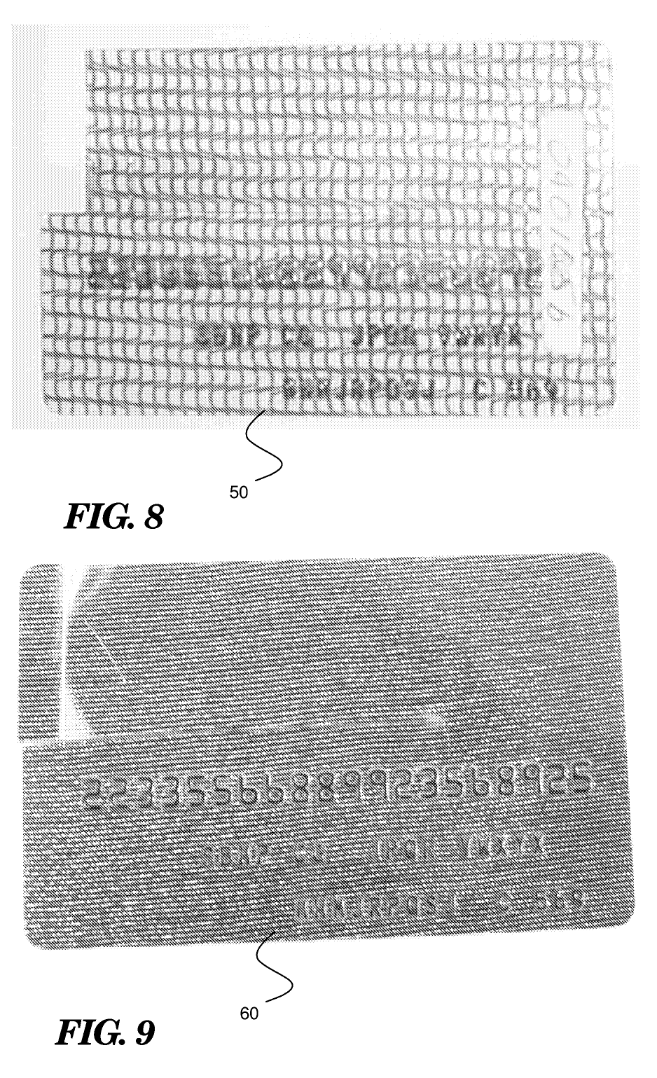

A photograph of the card produced by this example is shown by reference numeral 50 in FIG. 8. The card 50 had a total thickness of 30.5 mils. Following lamination, the card 50 was conventionally embossed without splitting or cracking. The bond between core sheets (layers 2 and 6) and the fabric (layer 5) was not separable by hand pull and thus greater than 2.0 lb.-ft./inch. The card 50 was transparent and showed a bright red metallic reflection of the mesh pattern.

### Example 4

Card structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Light Gold Shear Pea 0.078 g/sq. in. (Hobby Lobby) | --------------- |
| Layer 5 | Sericol SQL Clr1 Adhesive 160 mesh screen applied to layer 6 | --------------- |
| Layer 6 | Bolatron Empire Black #34320 color 2917 PVC core 10 mils | --------------- |
| Layer 7 | Klöckner CC-L280/07 with W5-51 × 704 adhesive 1.6 mils | --------------- |
| | (With Magstripe) | |

Card Features:

A photograph of the card produced by this example is shown by reference numeral 60 in FIG. 9. The card 60 had a total thickness of 31.3 mils. Following lamination, the card 60 was conventionally embossed without splitting or cracking. The bond between core sheets (layers 2 and 6) and the fabric (layer 5) was not separable by hand pull and thus greater than 2.0 lb.-ft./inch. The card 60 was opaque. When viewed straight-on, the card 60 had a visible organized multicolor sparkle pattern that followed the fabric grid. The sparkle pattern decreased in brightness when the viewing angle gradually changed from straight-on to 45 degrees from normal. When viewed at 45 degrees from normal, the sparkle pattern was not visible.

### Example 5

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Green Metallic Mesh 0.027 g/sq. in. (Hobby Lobby) | --------------- |
| Layer 5 | Decorative Coating 031605a 160 mesh screen applied to layer 6 | --------------- |
| Layer 6 | Klöckner CC-M230/18 white PVC core 13.5 mils | --------------- |
| Layer 7 | Klöckner CC-L280/07 with W5-51 × 704 adhesive 1.6 mils | --------------- |
| | (With Magstripe) | |

Card Features:

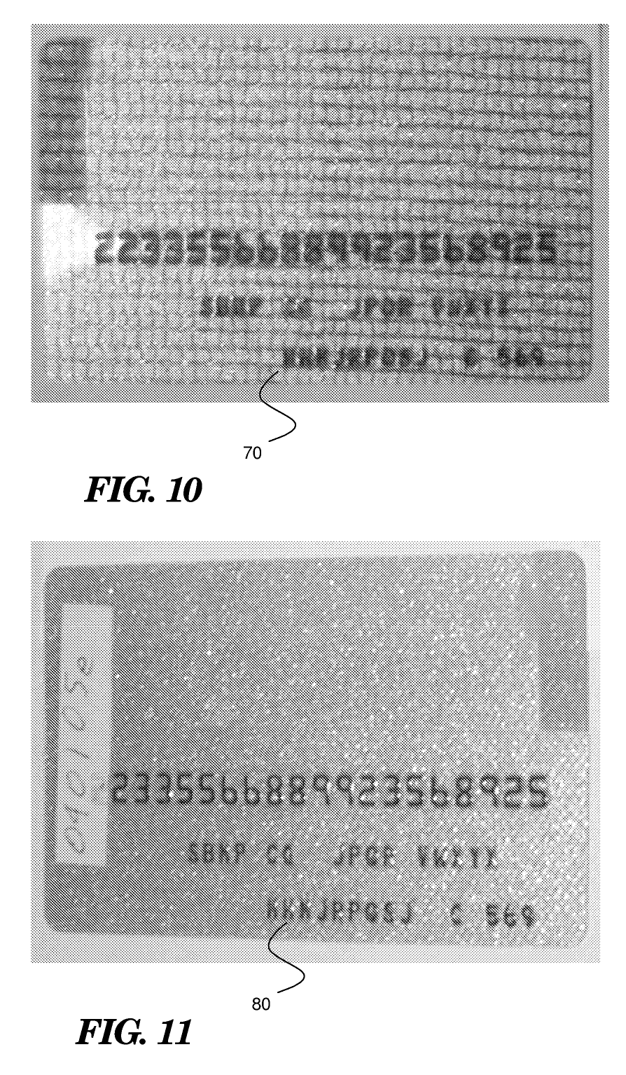

A photograph of the card produced by this example is shown by reference numeral 70 in FIG. 10. The card 70 had a total thickness of 31.3 mils. Following lamination, the card 70 was conventionally embossed without splitting or cracking. The bond between core sheets (layers 2 and 6) and the fabric (layer 5) was not separable by hand pull and thus greater than 2.0 lb.-ft./inch. The card 70 showed the bright green metallic reflection of the mesh pattern against a pearl background. The embossing letters appeared to float against the card background.

### Example 6

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | Blue Tulle 0.011 g/sq. in. (Hobby Lobby) | --------------- |
| Layer 5 | Decorative Coating 031605a 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |

Card Features:

A photograph of the card produced by this example is shown by reference numeral 80 in FIG. 11. The card 80 had a total thickness of 31.5 mils. Following lamination, the card 80 was conventionally embossed without splitting or cracking. The bond between core sheets (layers 2 and 6) and the fabric (layer 5) was not separable by hand pull and thus greater than 2.0 lb.-ft./inch. The card 80 was translucent. The card 80 had a fine grid pattern that appeared to float above a pearl background. The embossing letters appeared to float against the card background.

### Example 7

Card Structure:

Sealed Fabric Insert Sheet:

| | | |
|---|---|---|
| Layer 3 | Klöckner CC-L280/07 with W5-51 × 704 adhesive 1.6 mils | --------------- |
| Layer 4 | Metallic Gold Mesh 0.020 g/sq. in. (Hobby Lobby) | --------------- |
| Layer 5 | Klöckner CC-L280/07 with W5-51 × 704 adhesive 1.6 mils | --------------- |

Card:

| | | |
|---|---|---|
| Layer 1 | Klöckner CC-L280/07 with W5-51 × 704 adhesive | --------------- |
| Layer 2 | Klöckner CC-M278/12 clear PVC core 13.4 mils | --------------- |
| Layers 3, 4, 5 | Metallic Gold Mesh Sealed Insert 5.2 mils (Hobby Lobby) | --------------- |
| Layer 6 | Klöckner CC-M230/18 white PVC core 13.5 mils | --------------- |
| Layer 7 | Klöckner CC-L280/07 with W5-51 × 704 adhesive | --------------- |

Card Features:

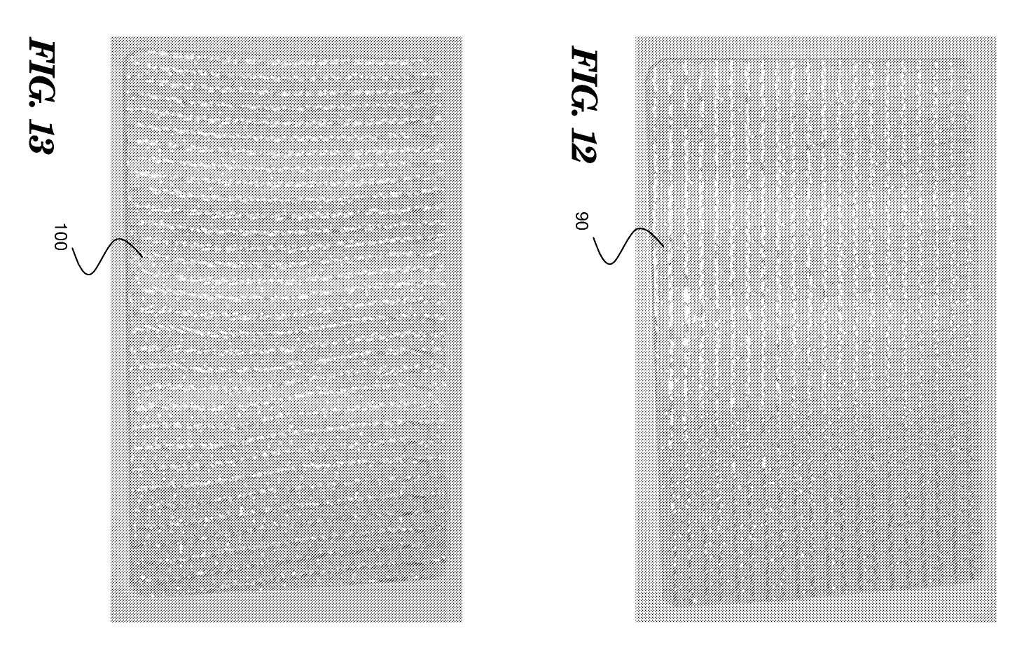

A photograph of the card produced by this example is shown by reference numeral 90 in FIG. 12. The card 90 had a total thickness of 34.7 mils, which is above industry thickness specifications. The bond between core sheets (layers 2 and 6) and the fabric (layer 5) was not separable hand pull and thus greater than 2.0 lb./in. The card 90 was opaque and had a coarse gold metallic grid pattern.

### Example 8

Card Structure:

Sealed Fabric Insert Sheet:

| | | |
|---|---|---|
| Layer 3 | Klöckner CC-L280/07 with W5-51 × 704 adhesive 1.6 mils | --------------- |
| Layer 4 | Metallic Gold Mesh 0.020 g/sq. in. (Hobby Lobby) | --------------- |
| Layer 5 | Klöckner CC-L280/07 with W5-51 × 704 adhesive 1.6 mils | --------------- |

Card:

| | | |
|---|---|---|
| Layer 1 | Klöckner CC-L280/07 with W5-51 × 704 adhesive | --------------- |
| Layer 2 | Klöckner CC-M278/12 clear PVC core 10.5 mils | --------------- |
| Layers 3, 4, 5 | Metallic Gold Mesh Sealed Insert 5.2 mils | --------------- |
| Layer 6 | Klöckner CC-M230/18 white PVC core 13.5 mils | --------------- |
| Layer 7 | Klöckner CC-L280/07 with W5-51 × 704 adhesive | --------------- |

Card Features:

A photograph of the card produced by this example is shown by reference numeral 100 in FIG. 13. The card 100 had a total thickness of 32.1 mils, which is within industry thickness specifications. The bond between core sheets (layers 2 and 6) and the fabric (layer 5) was not separable hand pull and thus greater than 2.0 lb./in. The card 100 was opaque and had a coarse gold metallic grid pattern.

### Example 9

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 12 mils | --------------- |
| | (With graphics applied to outer side) | |
| Layer 3 | NIR Block Formula 122205a applied 160 mesh screen to layer 2 | --------------- |
| Layer 4 | ADO 3300 1/21 Eurohem laser cut 0.05 g/sq. in. | --------------- |
| Layer 5 | NIR Block Formula 122205a applied 160 mesh screen to layer 6 | --------------- |
| Layer 6 | Klöckner CC-M230/18 white PVC core 12 mils | --------------- |
| | (With graphics applied to outer side) | |
| Layer 7 | Klöckner CC-L280/07 with W5-51 × 704 adhesive 1.6 mils | --------------- |
| | (With Kurz Hi Co. 330 2750 Silver Magstripe) | |

Card Features:

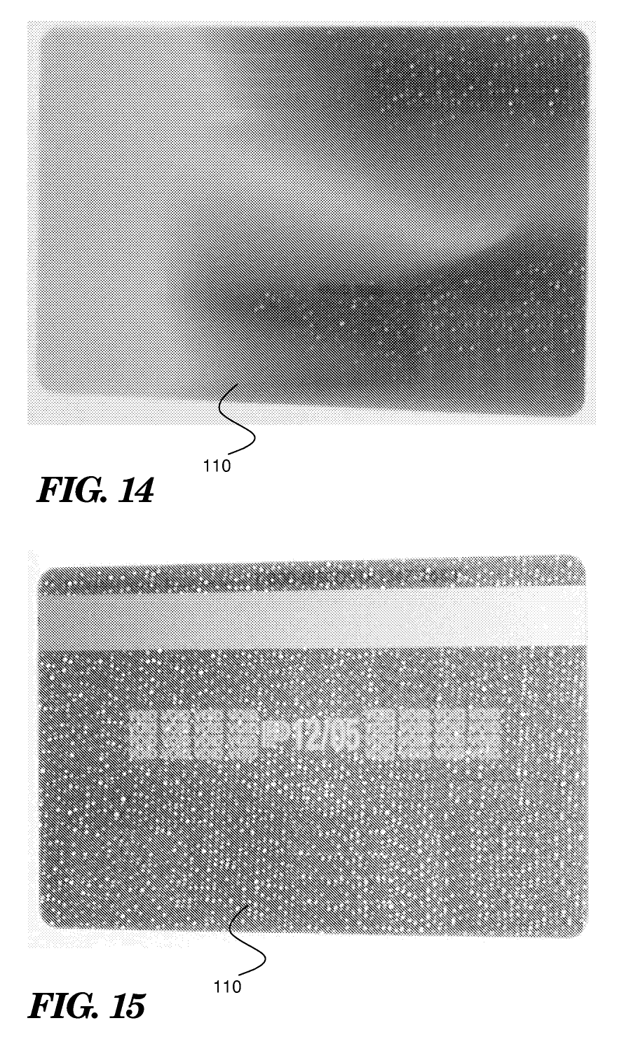

A photograph of the card produced by this example is shown by reference numeral 110 in FIGS. 14 and 15. FIG. 14 shows the front of the card 110 and FIG. 15 shows the back of the card. Note that proprietary printed matter and graphics have been removed in FIGS. 14 and 15 for security reasons. Ten 22.75″×27.75″ prelaminate sheet sets each comprising the seven card structure layers of this example were laminated in the Burkle Smartlam Model CHK Laminator per the cycle described above for this laminator. The laminated sheet sets were cut into individual 2.120″×3.375″ cards 110 in the PMC Die Cutter. The physical performance of the cards 110 was tested against the ISO/IEC 7810 Standards, and the cards met the requirements for bending stiffness, peel strength, chemical resistance, warpage and resistance to heat. The near infrared opacity of the cards 110 was sufficient to actuate common card readers having LED based sensing devices operating at 950 nm and 860 nm wavelengths. The thickness of the cards 110 averaged 32 mils. The bond between core sheets (layers 2 and 6) and the fabric (layer 5) was not separable by hand pull and thus greater than 2.0 lb.-ft./inch. The cards 110 were translucent teal in the non-printed areas. When viewed straight on, the non-printed areas of the cards 110 had a visible organized multicolor sparkle pattern that followed the fabric grid. The sparkle pattern disappeared when viewed at 45 degrees from normal.

### Example 10

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | ADO International 8484 1/80 Eurohem 0.011 g/sq. in. | --------------- |
| Layer 5 | Decorative Coating 031605a 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |
| | (With Magstripe) | |

Card Features:

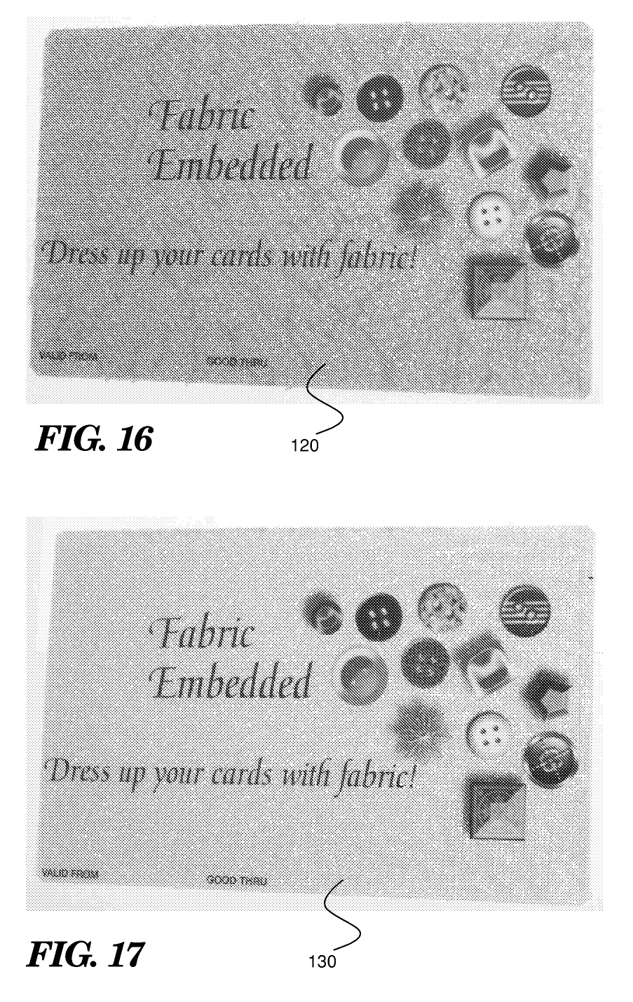

A photograph of the card produced by this example is shown by reference numeral 120 in FIG. 16. The card 120 had a total thickness of 32 mils. The bond between core sheets (layers 2 and 6) and the fabric (layer 4) was not separable by hand pull and thus greater than 2.0 lb.-ft./inch. The card 120 was opaque. The fabric had a printed pattern on it. Silver was visible through the fabric. When viewed at changing angles, depth was perceived due to parallax created by the fabric's translucent weave over the silver decorative coating. The fabric's printed pattern graphics appeared to hover over the fabric weave.

### Example 11

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | ADO International 3027 1/62 Eurohem 0.052 g/sq. in. | --------------- |
| Layer 5 | Decorative Coating 031605a 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |
| | (With Magstripe) | |

Card Features:

A photograph of the card produced by this example is shown by reference numeral 130 in FIG. 17. The card 130 had a total thickness of 32.9 mils. The bond between core sheets (layers 2 and 6) and the fabric (layer 4) was not separable by hand pull and thus greater than 2.0 lb.-ft./inch. The card 130 was opaque. The fabric had an embossed pattern on it. Silver was visible through the fabric. When viewed at changing angles, depth was perceived due to parallax created by the fabric's translucent weave over the silver decorative coating. The fabric's embossed pattern graphics appeared as a relief pattern within the fabric weave.

### Example 12

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | ADO International 3210 1/64 Eurohem 0.092 g/sq. in. | --------------- |
| Layer 5 | Decorative Coating 031605a 160 mesh screen applied to layer 6 | --------------- |
| Layer 6 | Klöckner CC-M278/12 clear PVC core 13.4 mils | --------------- |
| Layer 7 | Klöckner CC-L280/07 with W5-51 × 704 adhesive 1.6 mils | --------------- |
| | (With Magstripe) | |

Card Features:

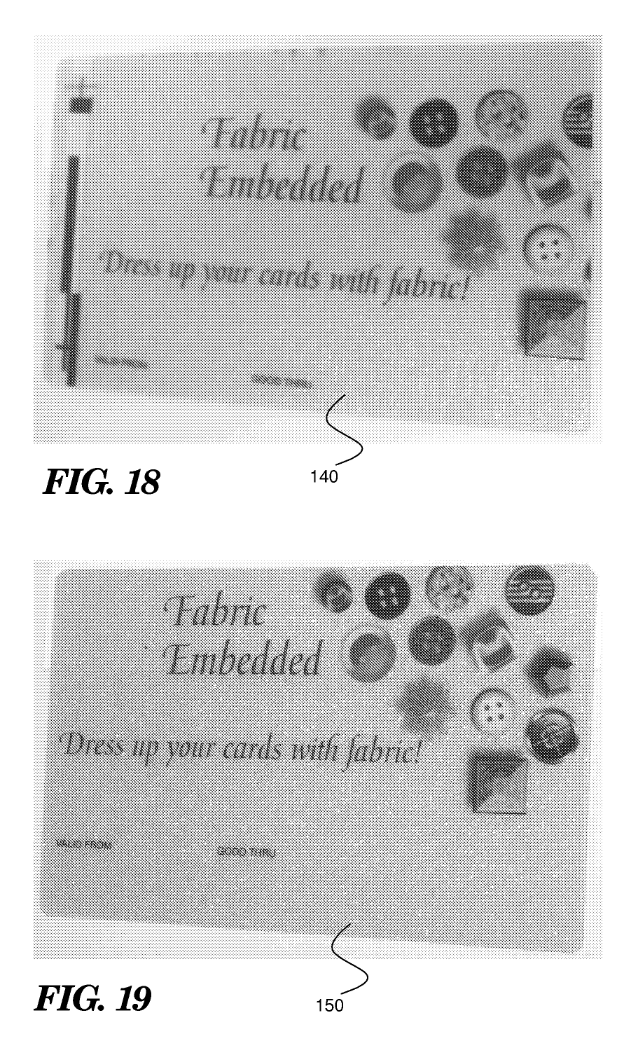

A photograph of the card produced by this example is shown by reference numeral 140 in FIG. 18. The card 140 had a total thickness of 32.9 mils. The bond between core sheets (layers 2 and 6) and the fabric (layer 4) was not separable by hand pull and thus greater than 2.0 lb.-ft./inch. The card 140 was opaque. The fabric had an embossed pattern on it. Silver was visible through the fabric. When viewed at changing angles, depth was perceived due to parallax created by the fabric's translucent weave over the silver decorative coating. The fabric's embossed pattern graphics appeared as a relief pattern within the fabric weave.

### Example 13

Card Structure:

| | | |
|---|---|---|
| Layer 1 | Klöckner CC-L280/07 with W5-51 × 704 adhesive 1.6 mils | --------------- |
| Layer 2 | Klöckner CC-M278/12 clear PVC core 13.4 mils | --------------- |
| Layer 3 | Sericol SQL Clr1 Adhesive 160 mesh screen applied to layer 2 | --------------- |
| Layer 4 | ADO International 3005 1/60 Eurohem 0.054 g/sq. in. | --------------- |
| Layer 5 | Sericol SQL Clr1 Adhesive 160 mesh screen applied to layer 6 | --------------- |
| Layer 6 | Klöckner CC-M278/12 clear PVC core 13.4 mils | --------------- |
| Layer 7 | Decorative Coating 031605a 160 mesh screen applied to layer 6 | --------------- |
| Layer 8 | Klöckner CC-L280/07 with W5-51 × 704 adhesive 1.6 mils | --------------- |
| | (With Magstripe) | |

Card Features:

A photograph of the card produced by this example is shown by reference numeral 150 in FIG. 19. The card 150 had a total thickness of 31.5 mils. The bond between core sheets (layers 2 and 6) and the fabric (layer 4) was not separable by hand pull and thus greater than 2.0 lb.-ft./inch. The card 150 was translucent. The fabric had an embossed pattern on it. Silver was visible through the fabric, although less so than in examples 10-12 because the silver decorative coating did not permeate trough the backside of the fabric. The fabric appeared to have a slight sparkle and shimmer to it. The effect was different than the depth effect created in examples 10-12.

Accordingly, a fabric-embedded financial transaction card has been disclosed and benefits and advantages of the invention relative to currently existing card manufacturing methods have been described. Summarizing, these benefits and advantages include the ability to provide financial transaction cards having heretofore unattainable visual effects, including decorative effects such as:
1) The effect of optically variability and color shifting with angle of viewing as displayed in the pattern of the embedded fabric;
2) The effect of pearlescence as displayed in the visual texture pattern of the embedded fabric;
3) The effect of metallic reflection as displayed in the visual texture pattern of the embedded fabric;
4) The effect of sparkle as displayed in the visual texture pattern of the embedded fabric;
5) The effect of embossment (holographic and other) as displayed in the visual texture pattern of the embedded fabric;
6) The effect of depth through organized moire effects between printed layers, decorative coatings, and the pattern of the embedded fabric; and
7) The effect of graphic and/or special effect pattern shifts with angle of viewing as displayed in the visual texture pattern of the embedded fabric.
   The invention thus provides the ability to manufacture financial transaction cards having a unique appearance that is not possible through current card manufacturing methods that provide conventional optical effects.

While various embodiments have been shown and described, it should be apparent that many variations and alternative embodiments would be apparent to those skilled in the art in view of the teachings herein. For example, although various types of fabric materials, thermoplastic materials, decorative coating materials are mentioned as being suitable in a financial transaction card, other varieties of these materials could no doubt also be used in accordance with the invention. It will be understood, therefore, that the invention is not to be in any way limited except in accordance with the spirit of the appended claims and their equivalents.

What is claimed is:

1. A financial transaction card, comprising:
a first thermoplastic material sheet having first and second substantially planar surfaces bounded by a continuous peripheral edge;
a second thermoplastic material sheet having first and second substantially planar surfaces bounded by a continuous peripheral edge;
a fabric material sheet disposed between said first and second thermoplastic material sheets;
at least one of said thermoplastic material sheets having a viewing area covering said fabric material sheet that is sufficiently transparent or translucent to human visible light to allow said fabric material sheet to be viewed through said viewing area; and
a machine-readable financial information storage or reference device;
whereby said fabric material sheet imparts a visual effect to said card.

2. A financial transaction card in accordance with claim 1 wherein said first and second thermoplastic material sheets are core sheets.

3. A financial transaction card in accordance with claim 1 wherein said fabric material sheet comprises a laminate insert having fabric material disposed between a pair of thermoplastic cover sheets.

4. A financial transaction card in accordance with claim 1 wherein said fabric material sheet is coextensive with said continuous peripheral edges of said thermoplastic material sheets such that said fabric material sheet covers opposing surfaces of said thermoplastic material sheets.

5. A financial transaction card in accordance with claim 4 wherein said viewing area is coextensive with its associated thermoplastic material sheet's continuous peripheral edge such that said fabric material sheet is viewable over the entirety of said sheet except where said associated thermoplastic material sheet is covered by printing or other features.

6. A financial transaction card in accordance with claim 1 wherein said viewing area is less than the surface area its associated thermoplastic material sheet such that said fabric material sheet is only viewable over a portion of said sheet.

7. A financial transaction card in accordance with claim 1 wherein said viewing area is shaped and has associated optical properties, and wherein its associated thermoplastic material sheet has different optical properties outside of said viewing area to provide a non-viewing area or another viewing area whose optical properties differ from those of said viewing area.

8. A financial transaction card in accordance with claim 1 wherein both of said thermoplastic material sheets have a viewing area covering said fabric material sheet that is sufficiently transparent or translucent to human visible light to allow said fabric material sheet to be viewed through both of said thermoplastic material sheets.

9. A financial transaction card in accordance with claim 1 further including an adhesive layer between said fabric material sheet and each of said thermoplastic material sheets.

10. A financial transaction card in accordance with claim 1 wherein one or both of said thermoplastic material sheets have printed information on surfaces thereof.

11. A financial transaction card in accordance with claim 10 further including overlay sheets covering said printed information on said first and second thermoplastic material sheets.

12. A financial transaction card in accordance with claim 1 wherein said card is one of a credit card, debit card, automated teller machine (ATM) card, gift card and telephone card.

13. A financial transaction card in accordance with claim 1 wherein first and second thermoplastic material sheets comprise a thermoplastic material selected from the group consisting of polyvinyl chloride (PVC), polyethylene terephthalate glycolized (PETG), unmodified amorphous polyethylene terephthalate (APET), acrylonitrile-butadiene-styrene (ABS), general purpose polystyrene (GPPS), high impact polystyrene (HIPS) and combinations of the foregoing.

14. A financial transaction card in accordance with claim 1 wherein said fabric material sheet comprises a woven or non-woven fabric that is capable of being heat laminated to said first and second thermoplastic material sheets at a bond strength of at least 2.0 pound-foot/inches applied as a 90 degree peel force.

15. A financial transaction card in accordance with claim 1 wherein said fabric material sheet comprises a woven or non-woven fabric having a weight that does not exceed 0.15 grams/square inch.

16. A financial transaction card in accordance with claim 1 wherein said fabric material sheet comprises a fabric selected from the group consisting of mesh, fine polyester, metallic polyester, tulle, matte tulle, shiny tulle, sheer, fantasy sheer, organza, netting, nylon netting, lame', rainbow lame', metallic mesh, sheer pea, fine chiffon, net, fishnet, stretch, crepe, lace and holographic fabric.

17. A financial transaction card in accordance with claim 1 wherein said fabric material sheet, said first thermoplastic material sheet and said second thermoplastic material sheet are non-decorative.

18. A financial transaction card in accordance with claim 1 wherein said fabric material sheet is decorative or non-decorative and one of said first and second thermoplastic material sheets is decorative so as to alter the appearance of said fabric material sheet by providing a decorative filter through which said fabric material sheet is viewed or by providing a decorative background to view said fabric material sheet against.

19. A financial transaction card in accordance with claim 1 wherein said fabric material sheet is decorative or non-decorative and both of said first and second thermoplastic material sheets are decorative so as to alter the appearance of said fabric material sheet by providing a decorative filter through which said fabric material sheet is viewed or by providing a decorative background to view said fabric material sheet against.

20. A financial transaction card in accordance with claim 1 wherein said fabric material sheet is translucent and one of said first and second thermoplastic material sheets is decorative so as to alter the appearance of said fabric material sheet by providing a decorative filter through which said fabric material sheet is viewed or by providing a decorative background to view said fabric material sheet against.

21. A financial transaction card in accordance with claim 1 wherein said fabric material sheet is decorative or non-decorative and one of said first and second thermoplastic material sheets has a reflective or metallized surface at the interface between said one thermoplastic material sheet and said fabric material sheet that provides an embossment of said fabric material sheet in said metallized or reflective layer.

22. A method of forming a financial transaction card, comprising:
selecting a first thermoplastic material sheet having first and second substantially planar surfaces bounded by a continuous peripheral edge;
selecting a second thermoplastic material sheet having first and second substantially planar surfaces bounded by a continuous peripheral edge;
placing a fabric material sheet between said first and second thermoplastic material sheets;
heat-laminating said thermoplastic and fabric material sheets to form a bonded laminate card structure;
at least one of said thermoplastic material sheets having a viewing area covering said fabric material sheet that is sufficiently transparent or translucent to human visible light to allow said fabric material sheet to be viewed through said viewing area; and
mounting a machine-readable financial information storage or reference device on said card;
whereby said fabric material sheet imparts a visual effect to said card.

23. A method in accordance with claim 22 wherein said fabric material sheet comprises a laminate insert having fabric material disposed between a pair of thermoplastic cover sheets.

24. A financial transaction card, comprising:
a first thermoplastic material sheet having first and second substantially planar surfaces bounded by a continuous peripheral edge;
a second thermoplastic material sheet having first and second substantially planar surfaces bounded by a continuous peripheral edge;
a fabric material sheet disposed between said first and second thermoplastic material sheets;
at least one of said thermoplastic material sheets having a viewing area covering said fabric material sheet that is sufficiently transparent or translucent to human visible light to allow said fabric material sheet to be viewed through said viewing area; and
a machine readable financial information storage or reference device;
whereby said fabric material sheet imparts a visual effect to said card;
said first and second thermoplastic material sheets being core sheets;
said fabric material sheet being coextensive with said continuous peripheral edges of said thermoplastic material sheets such that said fabric material sheet is coextensive with opposing surfaces of said thermoplastic material sheets;
one or both of said thermoplastic material sheets having printed information on surfaces thereof;
overlay sheets covering said printed information on said first and second thermoplastic material sheets;
said card being one of a credit card, debit card, automated teller machine (ATM) card, gift card and telephone card;
said first and second thermoplastic material sheets comprising a thermoplastic material selected from the group consisting of polyvinyl chloride (PVC), polyethylene terephthalate glycolized (PETG), unmodified amorphous polyethylene terephthalate (APET), acrylonitrile-butadiene-styrene (ABS), general purpose polystyrene (GPPS) high impact polystyrene (HIPS) and combinations of the foregoing;
said fabric material sheet comprising a woven or non-woven fabric that is capable of being heat laminated to said first and second thermoplastic material sheets at a bond strength of at least 2.0 pound-foot/inches applied as a 90 degree peel force;
said fabric material sheet comprising a woven or non-woven fabric having a weight that does not exceed 0.15 grams/square inch;
said fabric material sheet comprising a fabric selected from the group consisting of mesh, fine polyester, metallic polyester, tulle, matte tulle, shiny tulle, sheer, fantasy sheer, organza, netting, nylon netting, lame', rainbow lame', metallic mesh, sheer pea, fine chiffon, net, fishnet, stretch, crepe, lace or holographic fabric; and
said fabric material, said first thermoplastic material sheet and said second thermoplastic material sheet being decorative or non-decorative, according to any desired combination.
